(19) United States
(12) Patent Application Publication
(10) Pub. No.: US 2013/0004028 A1
(43) Pub. Date: Jan. 3, 2013

(54) Method for Filtering Using Block-Gabor Filters for Determining Descriptors for Images

(76) Inventors: Michael J. Jones, Belmont, MA (US); Tim K. Marks, Newton, MA (US)

(21) Appl. No.: 13/171,170

(22) Filed: Jun. 28, 2011

(51) Int. Cl. G06K 9/46

(52) U.S. Cl. 382/118; 382/190; 382/170

(57) ABSTRACT

A Gabor filter is approximated as a block-Gabor filter. The Gabor filter is represented by a matrix of numbers in which each number is a sample derived from a continuous Gabor function. The block-Gabor filter is partitioned into a set of blocks. Identical filter values are assigned to all the pixels in any particular block based on the Gabor filter. Then, a feature can be extracted from an image by filtering the image with a set of the block-Gabor filters to obtain a corresponding set of filtered images. Each filtered image is partitioned into regions of pixels. For each pixel, an N-bit signature is determined. Histograms of the N-bit signatures of the pixels in each region are combined to form the feature. The features of multiple images can be used for face recognition.

### FIELD OF THE INVENTION

This invention relates generally to digital filters, and more particularly to determining descriptors for objects in images, such as faces, for object recognition, face recognition, and object tracking.

### BACKGROUND OF THE INVENTION

Object recognition and face recognition are used in many computer vision applications. Faces are a most convenient biometric for recognizing people. Therefore, face recognition is used in various security applications, as well as in image and video search applications.

A basic approach has emerged that acquires an image of an unknown face, normalizes and crops the image to a fixed size, determines a descriptor, which serves as a unique characterization of the face, and then compares the descriptor to descriptors of known faces in a database (gallery) to obtain a similarity score. If the similarity score is above a predetermined threshold for a particular known face, then the faces are classified as being associated with the same person.

Many object recognition systems use Gabor filters applied to an image to extract salient features. A 2D Gabor filter is 2D matrix of numbers obtained by sampling a 2D Gabor function on a grid of discrete locations in an input plane. In a spatial domain, a 2D Gabor function is the product of a Gaussian function and a sinusoidal function. An example of a pair of conventional 2D Gabor functions in the real domain and the imaginary domain are shown in FIGS. 1A-1B, respectively. Note that the function values (represented by heights in FIGS. 1A-1B) vary continuously.

FIGS. 1C-1D show the Gabor functions rotated 45° in the horizontal plane.

In the prior art, Gabor filters are linear filters that are typically applied to images for edge detection and orientation determination. The Gabor filter resembles the receptive fields of some neurons in the human visual system. Therefore, the Gabor filter is particularly appropriate for texture representation and discrimination.

For example, one prior art method determines a local Gabor binary pattern histogram sequence (LGBPHS). That method uses conventional Gabor filters. However, the LGBPHS method using conventional Gabor filters is slow to determine and requires a large amount of memory. Furthermore, the LGBPHS method uses local binary patterns (LBP) to populate its histograms. The LGBPHS descriptor uses 40 Gabor filter pairs, 32-bin histograms, and 8×16=128 histogram regions. Thus, that method requires 40×32×128=163,840 bytes to store a descriptor.

There is a need for a descriptor that is fast to determine, memory efficient, and also maintains excellent accuracy.

### SUMMARY OF THE INVENTION

A descriptor is determined for an image by filtering the image with a set of block-Gabor filters to obtain a corresponding set of filtered images. The block-Gabor filters approximate conventional Gabor filters. In a 2D Gabor filter's input space, the regions over which the values of the filter are positive and the regions over which the filter's values are negative are well approximated by rectangular regions of pixels. The block-Gabor filter approximates these regions using rectangles, and within each rectangle, the value of the block-Gabor filter is constant.

After filtering the input image with the set of block-Gabor filters to obtain a set of filtered images, each filtered image is partitioned into regions of pixels. For each pixel, an N-bit signature is determined based on a local neighborhood of the pixel in the filtered image. Then, for each region, a histogram of the N-bit signatures of the pixels in the region is constructed to form the descriptor. In a preferred embodiment, the N-bit signature of each pixel is a gradient polarity signature, wherein each bit in the N-bit gradient polarity signature is a binary value based on gradient values of the filtered image in the local neighborhood of the pixel.

In one embodiment, an integral image is generated from the original image to enable efficient determination of the block-Gabor filtered image. In some embodiments, the block-Gabor filters are oriented at 0, 45, 90, and 135 degrees.

### BRIEF DESCRIPTION OF THE DRAWINGS

FIGS. 1A-1B are schematics of a pair of conventional Gabor functions in the real domain and the imaginary domain, respectively;

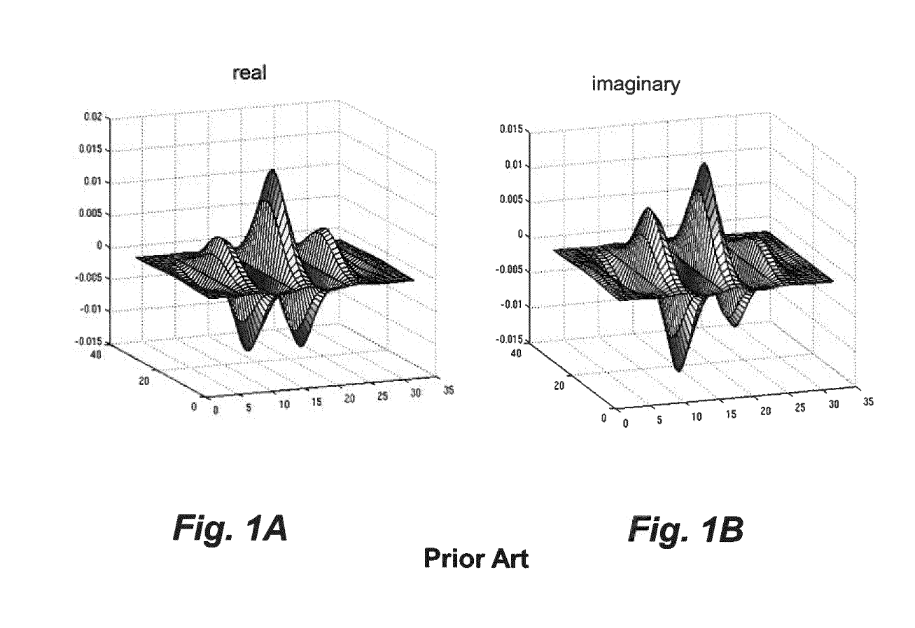

FIGS. 1C-1D are schematics of a pair of conventional Gabor functions that are oriented at 45 degrees with respect to the x and y axes;

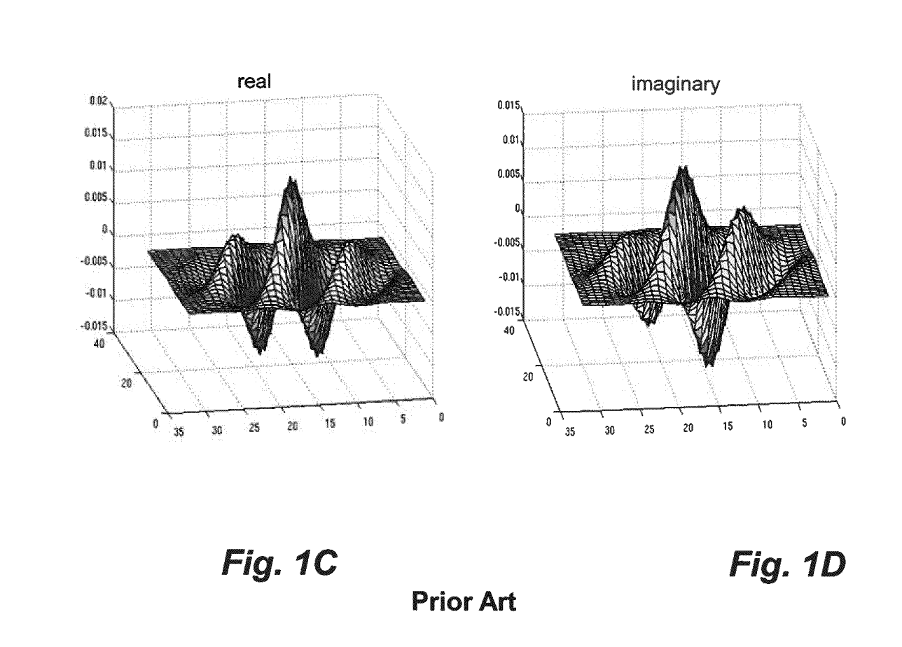

FIGS. 2A-2B are schematics of a pair of block-Gabor filters, according to embodiments of the invention, in the real domain and the imaginary domain, respectively;

FIGS. 2C-2D are schematics of a pair of block-Gabor filters that are oriented at 45 degrees with respect to the x and y axes, according to embodiments of the invention, in the real domain and imaginary domain, respectively;

FIG. 3 is a flow chart of a method for determining a descriptor for an image according to embodiments of the invention;

FIG. 4 is a schematic of an integral image and using an integral image to determine the sum of pixels in a rectangular region according to embodiments of the invention;

FIG. 5 is a schematic of a local area of pixels for determining an N-bit gradient polarity signature according to embodiments of the invention;

FIG. 6 is a schematic of a partitioning of a filtered image according to embodiments of the invention;

FIG. 7 is a schematic of a 45-degree integral image and using a 45-degree integral image to determine the sum of pixels in a 45-degree rotated pixelated rectangular region according to embodiments of the invention;

FIGS. 8A-8B are schematics of pixelated rectangles, according to embodiments of the invention, at a 45-degree angle with respect to an underlying grid.

### DETAILED DESCRIPTION OF THE PREFERRED EMBODIMENT

The embodiments of the invention are based on our realization that we can determine a descriptor of an image that achieves an accuracy equal to the best methods known in the art, in about 1/100^{th} the amount of time. The descriptor is deter using a block-Gabor filter.

The block-Gabor filter is an approximation of a conventional Gabor filter. The Gabor filter is partitioned into a set of blocks, wherein the blocks are pixelated rectangles. Identical filter values are assigned to the pixels of any particular block based on the Gabor filter to generate the block-Gabor filter that approximates the Gabor filter.

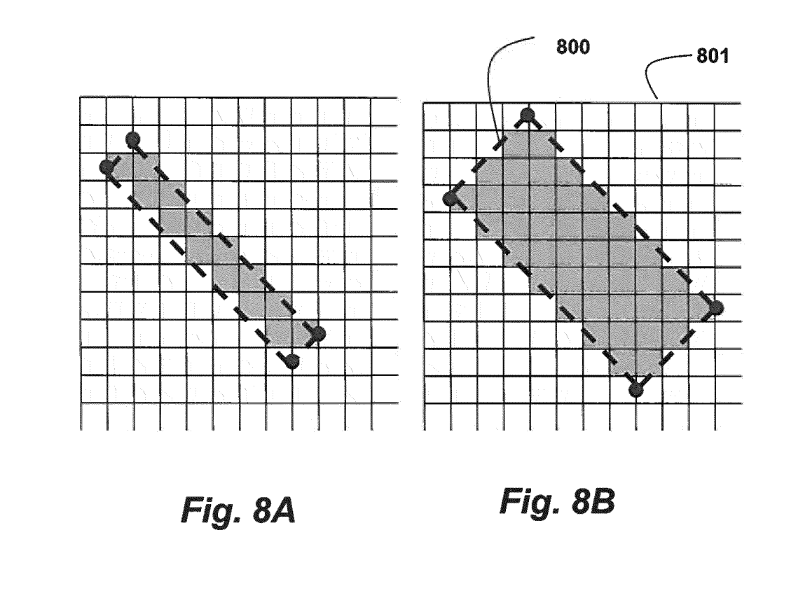

A pixelated rectangle is an approximation to a rectangle using pixels from an underlying grid. If the underlying grid is aligned with the axes of the rectangle, then the approximation is exact and the pixelated rectangle is simply a rectangular block of pixels. If the underlying grid is not aligned with the axes of the rectangle, then each of the four boundaries of the pixelated rectangle is a pixelated line segment. FIGS. 8A-B show two examples of pixelated rectangles in which the axes of the rectangle are rotated 45 degrees from the axes of the underlying grid.

The block-Gabor filter is applied to the pixels of an input image. The numerical value resulting from applying our block-Gabor filter to a region of the input image is determined using sums of pixels in pixelated rectangles distributed over the footprint of the filter. In contrast with the prior art, the block-Gabor filter includes one or more pixelated rectangular blocks, in which the filter value for every pixel in a block is the same real number, and this value for each block is chosen to approximate the conventional Gabor filter.

The integral image, or “summed area table,” enables the determination of a sum of pixels within a rectangle in a constant time independent of the number of pixels over which the sum is determined. We disclosed the integral image in U.S. Pat. Nos. 7,583,823, 7,212,651, 7,099,510, 7,020,337, incorporated herein by reference. Using the integral images makes our block-Gabor filter extremely efficient.

An image is filtered with the block-Gabor filter by centering the block-Gabor filter on each pixel of the image and determining the weighted sum of pixels within each pixelated rectangular region of the filter. The resulting scalar value is the output of the block-Gabor filter at that center pixel. In a preferred embodiment, the sums of pixels within each pixelated rectangular region are determined efficiently using the integral image representation of the input image. This filtering process is analogous to convolving an image with a conventional Gabor filter.

In one embodiment, each filter value is determined by filtering the image with a pair of two separate block-Gabor filters that approximate a conventional pair of Gabor filters that have the same scale and orientation and are 90° out of phase. The 90° out-of-phase filters come from the real and imaginary components of the complex Gabor function. The single value at each pixel of the final filtered image is obtained by combining the values of the two filtered images at the pixel, by taking the square root of the sum of their squares.

Note that it is possible to use a different way of determining block-Gabor filters, such as standard 2D convolution, which can be accelerated using specialized hardware such as graphics processing units. Also, some of the block-Gabor filters are at a 45° angle, and we use an additional 45° integral image to efficiently apply the block-Gabor filters that are at the 45° angle. In other words, two integral images are actually determined in one embodiment.

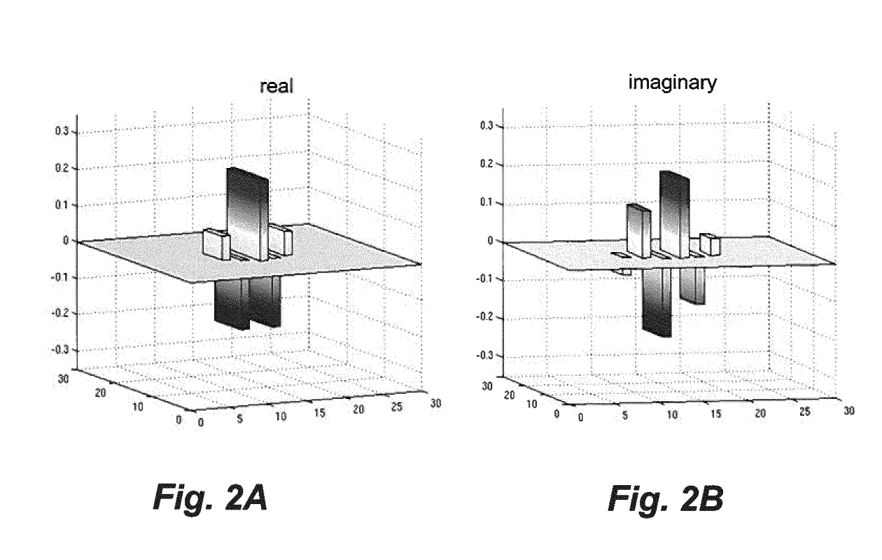

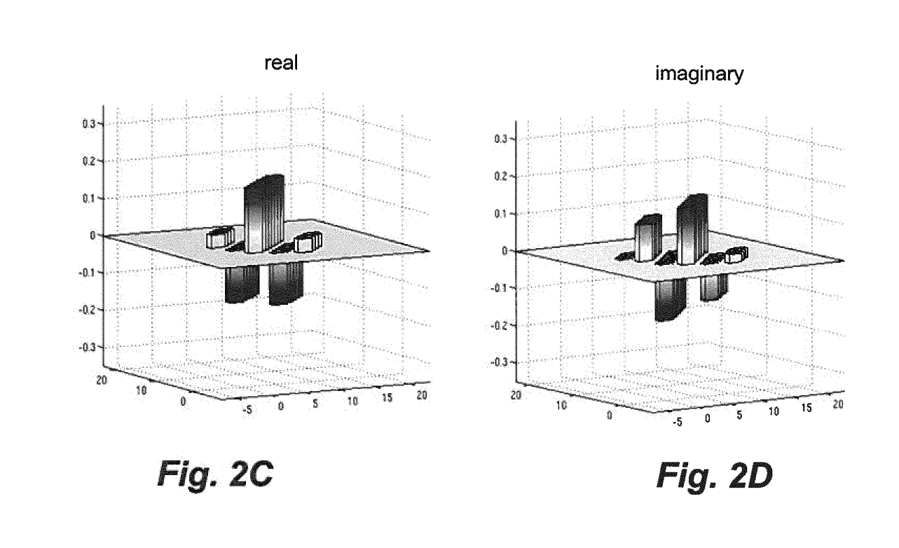

FIGS. 2A-2B show an example of a pair of our block-Gabor filters in the real domain and imaginary domain, respectively. In the Figs., the horizontal axes indicate the axes of an underlying grid, and the vertical axis the filter values. Each block is a pixelated rectangle that approximates a rectangle which has a length axis and a width axis, and the block is aligned with the sinusoidal function such that the length axis lies on a line of constant values of the sinusoidal function. In these examples, because the underlying grid is aligned with the axes of the rectangle, the approximation is exact and the pixelated rectangle is simply a rectangular block of pixels.

FIGS. 2C-2D show an example of a pair of our block-Gabor filters that are oriented at 45 degrees with respect to the x and y axes, in the real domain and imaginary domain, respectively. In the Figs., the horizontal axes indicate the axes of an underlying grid, and the vertical axis the filter values. Each block is a pixelated rectangle that approximates a rectangle which has a length axis and a width axis, and the block is aligned with the sinusoidal function such that the length axis lies on a line of constant values of the sinusoidal function. In these examples, because the underlying grid is not aligned with the axes of the rectangle, each of the four boundaries of the pixelated rectangle is a pixelated line segment.

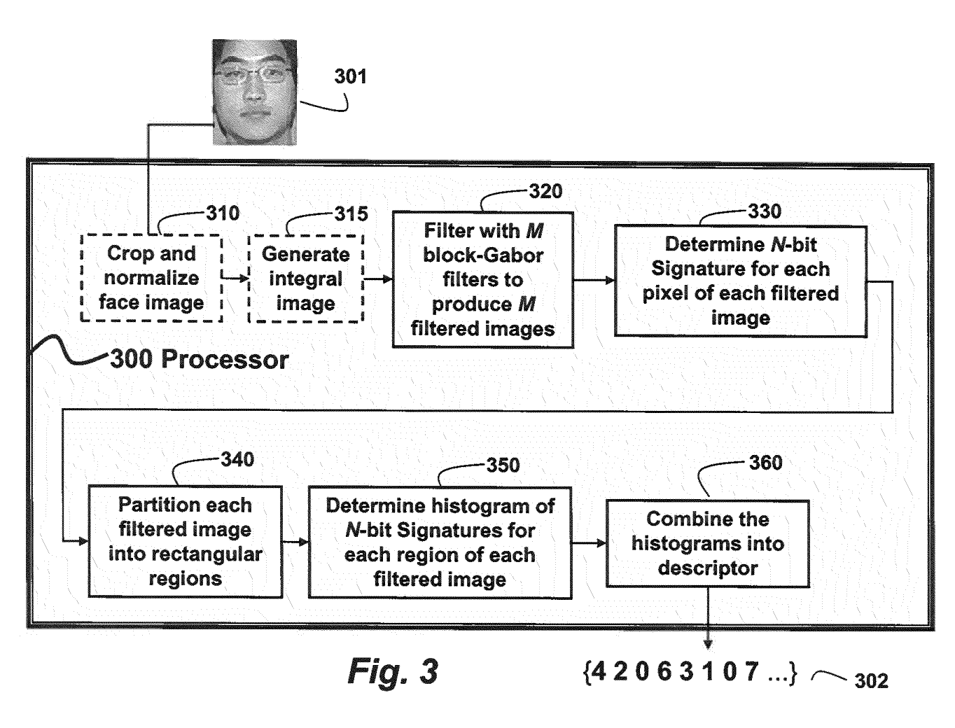

FIG. 3 shows a method for determining descriptors for an image according to an embodiment of our invention, specifically when the image is of a face. The descriptors can be used for object (face) recognition. However, it is understood that our block-Gabor filter can be used for other computer vision applications where it is necessary to determine a descriptor. It also understood that the invention is not limited to recognizing faces. The steps of the method can be performed in a processor 300 connected to a memory and input/output interfaces as known in the art.

In an optional preprocessing step, we crop and normalize 310 an image 301 of a face to a fixed size using automatic face and feature detectors.

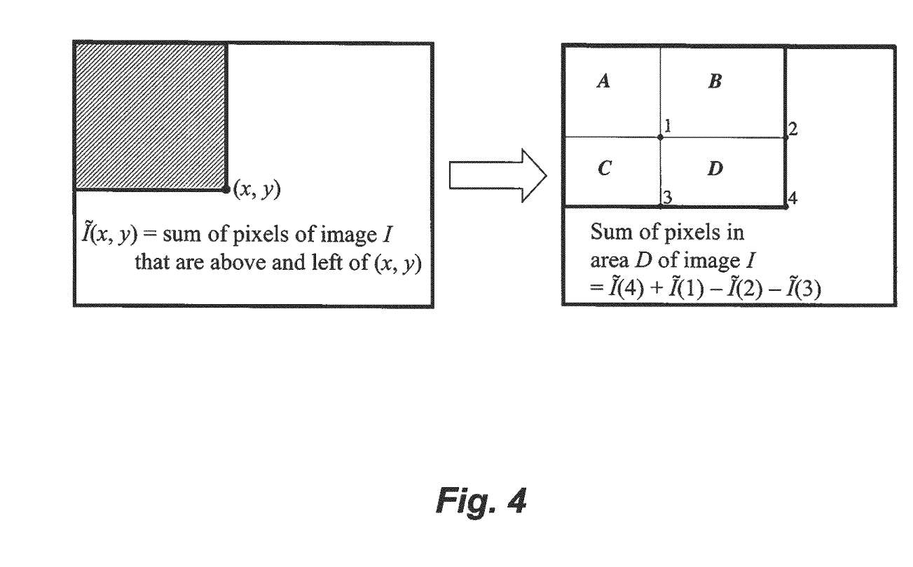

As shown in FIG. 4, an optional integral image can also be is generated 315 from the normalized input image I. The integral image, Ĩ(x, y) is defined as the sum of all pixels in the input image above and to the left of (x, y):

$$\tilde{I} ( x , y ) = {\sum }_{{{x}^{′} \leq x}_{{y}^{′} \leq y}}^{ } I ( {x}^{′} , {y}^{′} ) .$$

Then, any sum of pixels in a rectangular area of image I, such as the sum of the pixels in area D (shown in FIG. 4), can be determined in constant time as follows. We represent the sum of the pixel values in areas A, B, C, and D of image I by A, B, C, and D respectively,

$$\begin{matrix}D = \tilde{I} ( 4 ) + \tilde{I} ( 1 ) - \tilde{I} ( 2 ) - \tilde{I} ( 3 ) \\ = ( A + B + C + D ) + A - ( A + B ) - ( A + C ) \\ = D .\end{matrix}$$

The integral image can be used to efficiently filter an image with our block-Gabor filter oriented at 0 or 90 degrees.

In addition, to efficiently determine block-Gabor filters oriented at 45 or 135 degrees, a 45° integral image can be used. The 45° integral image Ĩ₄₅(x, y) is defined as

$${\tilde{I}}_{45} ( x , y ) = {\sum }_{{{x}^{′} \leq x ,}_{\vert {y}^{′} - y \vert \leq x - {x}^{′}}}^{ } I ( {x}^{′} , {y}^{′} ) .$$

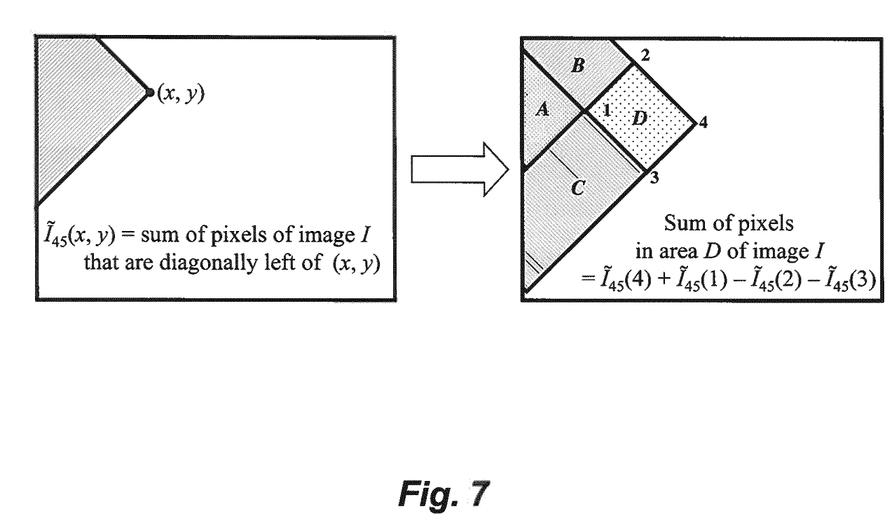

FIG. 7 shows the summation of pixels diagonally to the left of the pixel at location (x, y), and the determination for the sum of the pixels in area D when our filters are oriented at 45 or 135 degrees.

FIG. 8B shows a pixelated rectangle, which is an approximation to a rectangle using pixels from an underlying grid. If the underlying grid is aligned with the axes of the rectangle, then the approximation is exact and the pixelated rectangle is simply a rectangular block of pixels.

However, if the underlying grid is not aligned with the axes of the rectangle, then each of the four boundaries 800 of the pixelated rectangle is a pixelated line segment.

FIGS. 8A-8B show two examples of pixelated rectangles in which the axes of the rectangle are rotated 45° from the axes of the underlying grid 801.

If the block-Gabor filter is 3D, then the blocks are pixelated cuboids, instead of pixelated rectangles.

A set of M filtered versions of the image are generated 320. Each filtered image is determined by convolving two block-Gabor filters that approximate two 90° out-of-phase (conventional discrete) Gabor filters with each pixel in the image. Optionally, the value at each pixel of the filtered image can be determined efficiently using the appropriate integral image.

The two filter values, v₁ and v₂, at each pixel are combined by determining a magnitude \sqrt{v₁²+v₂²} for each pixel. Different pairs of block-Gabor filters differ in scale and orientation, and the two filters of a pair differ in phase, i.e., the filters approximate Gabor filters that are 90° degrees out of phase.

For each filtered image, an N-bit signature is determined 330 at each pixel. In the preferred embodiment, this is an N-bit gradient polarity signature. Each gradient polarity signature indicates a polarity of a directional local gradient at each pixel for each of N directions.

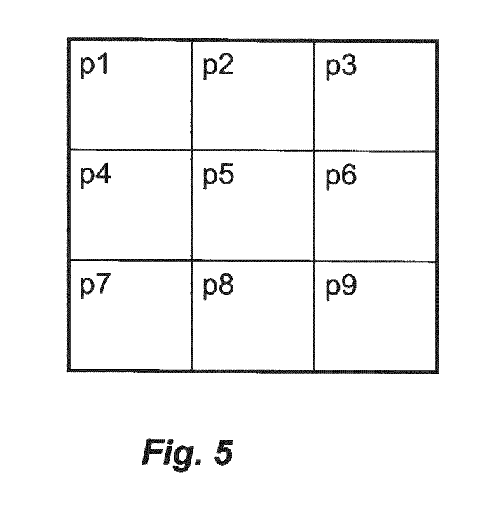

As shown in FIG. 5, for each pixel of the filtered image, a small neighborhood of the pixels surrounding the pixel is used to estimate the polarity (sign) of N directional gradients at the pixel. In this example, we use a 3×3 neighborhood of pixels, and determine the N binary values b₁, b₂, b_{N} (here N=3) as follows:

b₁=1 if p1+p5+p9>p2+p3+p6, 0 otherwise (diagonal gradient)

b₂=1 if p2+p5+p8>p3+p6+p9, 0 otherwise (vertical gradient)

b₃=1 if p1+p2+p3>p4+p5+p6, 0 otherwise (horizontal gradient).

The final N-bit gradient polarity signature for pixel p5 is a combination of the N bits: b₁ b₂ b₃. The combining could be a concatenation to determine a feature vector. Alternatively, the combining can result in a single integer or real number.

In another embodiment, the N-bit signature is a local binary pattern (LBP). Local Gabor Binary Pattern Histogram Sequences (LGBPHS) have been applied to face recognition. However, LBP has not been used with our block-Gabor filters. In the simplest form of LBP, the image is partitioned into regions, and for each pixel in a region, the pixel is compared to each of its eight neighbors. The neighboring pixels are followed along a circle, or counter-clockwise. If the central pixel is greater than its neighbor, the bit corresponding to that neighboring pixel is assigned 1, and 0 otherwise. This yields an eight-bit value called the local binary pattern. The set of local binary patterns within a region are used to populate a histogram, which can be normalized and combined as a descriptor, see e.g., US 20070112699, “Image verification method, medium, and apparatus using a kernel based discriminant analysis with a local binary pattern (LBP).”

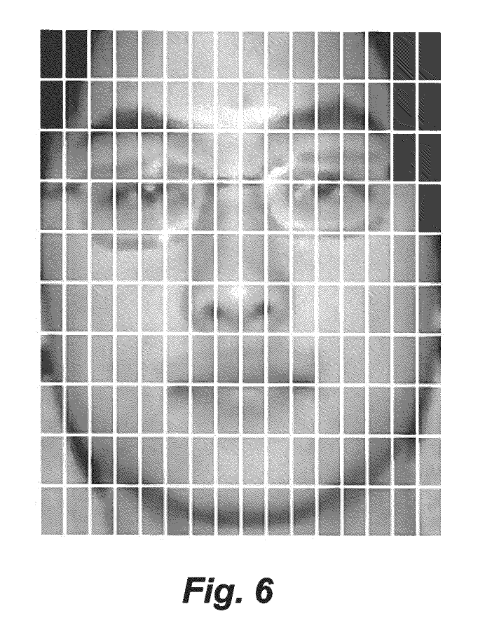

As shown in FIG. 6, the filtered image is partitioned 340 into a set of R regions, e.g., rectangular regions of size 8×4 pixels. It is understood that other sizes and shapes of regions can also be accommodated by the embodiment of the invention, and that these regions could be either non-overlapping as in the preferred embodiment or overlapping.

We determine 350 histograms of the N-bit signatures in each image region. Each histogram has 2^{N} bins. The bins of all histograms are combined to produce the descriptor 302. In a preferred embodiment, this combination is a concatenation of the bins into a vector. Because there are R regions and each region has a histogram with 2^{N} bins, the length of each descriptor is B=2^{N}R.

Then, two descriptors for two images can be compared using a histogram intersection:

$$S ( f , g ) = {\sum }_{i = 1}^{B} min ( {f}_{i} , {g}_{i} ) ,$$

where f and g are descriptors for the two images whose i^{th} elements are represented respectively by fᵢ and gᵢ, S(f, g) is a similarity score between vectors f and g, and the value returned by the function min is the minimum value of its input arguments. The similarity score can be used to determine whether the faces in the two images are similar or not. It is understood that other similarity functions for comparing histograms can also be accommodated by the embodiments of the invention.

Our descriptors can also be used for other applications, such as, but not limited to, process control, event detection, surveillance, organizing information, modeling objects or environments, object tracking, object recognition, machine learning, indexing, motion estimation, image restoration, content-based image retrieval, and pose estimation.

The prior art method LGBPHS with conventional Gabor filters requires 163,840 bytes to store a descriptor. In contrast, our block-Gabor filter descriptors in a preferred embodiment use 8 block-Gabor filter pairs, 8-bin histograms, and 128 histogram regions for a total of 8×8×128=8192 bytes to store our descriptor.

### Effect of the Invention

Our block-Gabor filter descriptors achieve approximately the same accuracy as prior art face recognizing methods in about two orders of magnitude (about a factor of 100) less time, with a twenty-fold reduction in memory requirements.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for approximating a Gabor filter as a block-Gabor filter, wherein the Gabor filter is a matrix of numbers in which each number is a sample derived from a continuous Gabor function, which is a product of a continuous Gaussian function and a sinusoidal function, comprising the steps of:
partitioning the Gabor filter into a set of blocks, wherein the blocks are pixelated rectangles; and
assigning identical filter values to the pixels of any particular block based on the Gabor filter to generate the block-Gabor filter that approximates the Gabor filter, wherein the steps are performed in a processor.

2. The method of claim 1, wherein each block approximates a rectangle that has a length axis and a width axis, and the block is aligned with the sinusoidal function such that the length axis lies on a line of constant values of the sinusoidal function.

3. The method of claim 2, wherein the length axes correspond to positive and negative peaks of the sinusoidal function.

4. The method of claim 3, wherein the filter value for the block is positive when the block corresponds to a positive peak of the sinusoidal function and negative when the block corresponds to a negative peak of the sinusoidal function.

5. The method of claim 1, wherein the sinusoidal function is a sine function.

6. The method of claim 1, wherein the sinusoidal function is a cosine function.

7. The method of claim 1, wherein the block-Gabor filter is 2D.

8. The method of claim 1, wherein the block-Gabor filter is 3D and the blocks are pixelated cuboids.

9. The method of claim 1, wherein the pixelated rectangles are rotated 45° from the axes of an underlying grid.

10. The method of claim 1, wherein each block is disjoint from the other blocks in the set.

11. The method of claim 1, further comprising:
determining a descriptor of an image including pixels, wherein the determining further comprises:
filtering the image with a set of the block-Gabor filters to obtain a corresponding set of filtered images;
determining an N-bit signature from a local neighborhood near each pixel in each filtered image;
partitioning each filtered image into a set of regions;
constructing a histogram of the N-bit signatures for each region; and
combining the histograms to form the descriptor of the image.

12. The method of claim 11, wherein the N-bit signature is an N-bit gradient polarity signature, wherein each bit of the N-bit gradient polarity signature indicates a polarity of a directional local gradient in the local neighborhood of the pixel for one of N directions.

13. The method of claim 11, further comprising:
generating an integral image from the image, and wherein the filtering is performed using the integral image.

14. The method of claim 11, further comprising:
generating a 45-degree integral image from the image, and wherein the filtering is performed using the 45-degree integral image.

15. The method of claim 11, wherein each filtered image is determined by convolving a pair of the block-Gabor filters with the image.

16. The method of claim 15, wherein the pair of block-Gabor filters approximate two 90° out-of-phase Gabor filters.

17. The method of claim 15, wherein outputs of the pair of block-Gabor filters at each pixel are v₁ and v₂, and further comprising:
combining the outputs according to \sqrt{v₁²+v₂²} to determine a magnitude of the pixel of the filtered image.

18. The method of claim 15, wherein different pairs of the block-Gabor filters differ in scale and orientation.

19. The method of claim 11, wherein the descriptor is compared with the descriptor of another image by using a histogram intersection:
$$S ( f , g ) = {\sum }_{i = 1}^{B} min ( {f}_{i} , {g}_{i} ) ,$$
where vectors f and g are the descriptors for the two images, fᵢ and gᵢ respectively represent the i^{th} element of the vectors f and g, B is a number of elements in each vector f and g, S(f, g) is a similarity score between vectors f and g, and the function min returns a minimum value.

20. The method of claim 19, wherein the similarity score is used to determine a similarity of the two images.

21. The method of claim 11 further comprising:
normalizing and cropping the image.

22. The method of claim 11, wherein the input image is of a face.

23. The method of claim 11, wherein the descriptor is used for face recognition.

24. The method of claim 11, wherein the combining concatenates the histograms, and the descriptor is a vector.

25. A memory for storing a data structure for access by an application program being executed on a processor, wherein the data structure approximates a Gabor filter as a block-Gabor filter;
a matrix of numbers stored in the memory to represent the Gabor filter, wherein each number is a sample derived from a continuous Gabor function, which is a product of the continuous Gaussian function and a sinusoidal function; and
a set of blocks stored in the memory, wherein the blocks are pixelated rectangles partitioned from the Gabor filter, and wherein identical filter values are assigned to the pixels of any particular block based on the Gabor filter.
